(19) United States
(12) Patent Application Publication
(10) Pub. No.: US 2016/0373739 A1
(43) Pub. Date: Dec. 22, 2016

(54) INTRA/INTER DECISIONS USING STILLNESS CRITERIA AND INFORMATION FROM PREVIOUS PICTURES

(71) Applicant: Microsoft Technology Licensing, LLC, Redmond, WA (US)

(72) Inventors: Thomas W. Holcomb, Bothell, WA (US); Chih-Lung Lin, Redmond, WA (US); You Zhou, Sammamish, WA (US); Ming-Chieh Lee, Bellevue, WA (US); Sergey Sablin, Stockholm (SE)

(73) Assignee: Microsoft Technology Licensing, LLC, Redmond, WA (US)

(21) Appl. No.: 14/741,191

(22) Filed: Jun. 16, 2015

(51) Int. Cl. H04N 19/11; H04N 19/176; H04N 19/137

(52) U.S. Cl. CPC H04N 19/11; H04N 19/137; H04N 19/176

(57) ABSTRACT

The computational complexity of video encoding is reduced by selectively skipping certain evaluation stages when deciding whether to use inter-picture prediction or intra-picture prediction for a unit of a picture. For example, a video encoder receives a current picture of a video sequence and encodes the current picture. As part of the encoding, for a current unit (e.g., coding unit, macroblock) of the current picture, the encoder can skip time-consuming evaluation of intra-picture prediction modes for blocks of the current unit in situations in which motion compensation for the current unit is already expected to provide effective rate-distortion performance, and use of intra-picture prediction is unlikely to improve performance. In particular, evaluation of the intra-picture prediction modes for blocks of the current unit can be skipped when the current unit has little or no movement and intra-picture prediction has not been promising for the collocated unit in the previous picture.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last 25 years, various video codec standards have been adopted, including the ITU-T H.261, H.262 (MPEG-2 or ISO/IEC 13818-2), H.263, and H.264 (MPEG-4 AVC or ISO/IEC 14496-10) standards, the MPEG-1 (ISO/IEC 11172-2) and MPEG-4 Visual (ISO/IEC 14496-2) standards, and the SMPTE 421M (VC-1) standard. More recently, the H.265/HEVC standard (ITU-T H.265 or ISO/IEC 23008-2) has been approved. Extensions to the H.265/HEVC standard (e.g., for scalable video coding/decoding, for coding/decoding of video with higher fidelity in terms of sample bit depth or chroma sampling rate, for screen capture content, or for multi-view coding/decoding) are currently under development. A video codec standard typically defines options for the syntax of an encoded video bitstream, detailing parameters in the bitstream when particular features are used in encoding and decoding. In many cases, a video codec standard also provides details about the decoding operations a video decoder should perform to achieve conforming results in decoding. Aside from codec standards, various proprietary codec formats define other options for the syntax of an encoded video bitstream and corresponding decoding operations.

As new video codec standards and formats have been developed, the number of coding tools available to a video encoder has steadily grown, and the number of options to evaluate during encoding for values of parameters, modes, settings, etc. has also grown. At the same time, consumers have demanded improvements in temporal resolution (e.g., frame rate), spatial resolution (e.g., frame dimensions), and quality of video that is encoded. As a result of these factors, video encoding according to current video codec standards and formats is very computationally intensive. Despite improvements in computer hardware, video encoding remains time-consuming and resource-intensive in many encoding scenarios.

### SUMMARY

In summary, the detailed description presents innovations in video encoding. In particular, the innovations can reduce the computational complexity of video encoding by selectively skipping certain evaluation stages when deciding whether to use inter-picture prediction or intra-picture prediction for a unit of a picture. For example, based on various conditions, a video encoder selectively skips evaluation of intra-picture prediction modes (“IPPMs”) for blocks of a unit when the IPPMs are not expected to improve the rate-distortion performance of encoding (e.g., by lowering bit rate and/or improving quality).

According to one aspect of the innovations described herein, a video encoder receives a current picture of a video sequence and encodes the current picture. As part of the encoding of the current picture, for a current unit (e.g., coding unit, macroblock) of the current picture, the video encoder determines, for the current unit, first information that indicates a cost of encoding the current unit using motion compensation. The video encoder checks whether movement indicated by one or more motion vectors for the current unit satisfies stillness criteria. If so, the video encoder determines second information for the current unit, where the second information indicates a cost of encoding a collocated unit of a previous picture using intra-picture prediction. Then, based at least in part on the first information and the second information, the video encoder checks whether to skip intra-picture prediction for the current unit and, if so, skips the intra-picture prediction for the current unit. Otherwise (if intra-picture prediction is not to be skipped for the current unit), the video encoder evaluates one or more IPPMs for blocks of the current unit. In this way, the video encoder can skip time-consuming evaluation of IPPM(s) in situations in which motion compensation for the current unit is already expected to provide effective rate-distortion performance, and use of intra-picture prediction is unlikely to improve rate-distortion performance. In particular, evaluation of the IPPMs for blocks of a current unit can be skipped when the current unit has little or no movement and intra-picture prediction has not been promising for the unit in the previous picture.

According to another aspect of the innovations described herein, a video encoder system includes a motion estimator, a buffer, an encoding control, and an intra-picture prediction estimator. The motion estimator is configured to determine, for a current unit of a current picture, first information that indicates a cost of encoding the current unit using motion compensation. The buffer is configured to store second information that indicates a cost of encoding a collocated unit of a previous picture using intra-picture prediction. The encoding control is configured to check whether movement indicated by motion vector(s) for the current unit satisfies stillness criteria. The encoding control is further configured to, if the movement satisfies the stillness criteria, determine (for the current unit) the second information and check, based at least in part on the first information and the second information, whether to skip intra-picture prediction for the current unit. The intra-picture prediction estimator is configured to, if intra-picture prediction is not to be skipped for the current unit, evaluate one or more IPPMs for blocks of the current unit. In this way, the video encoder can avoid evaluation of the IPPM(s) when intra-picture prediction is unlikely to improve rate-distortion performance during encoding for the current unit, which tends to speed up encoding.

The innovations can be implemented as part of a method, as part of a computing system configured to perform the method or as part of a tangible computer-readable media storing computer-executable instructions for causing a computing system to perform the method. The various innovations can be used in combination or separately. For example, in some implementations, all of the innovations described herein are incorporated in video encoding decisions. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram illustrating an example computing system in which some described embodiments can be implemented.

FIGS. 2a and 2b are diagrams illustrating example network environments in which some described embodiments can be implemented.

FIG. 3 is a diagram illustrating an example video encoder system in conjunction with which some described embodiments can be implemented.

FIGS. 4a and 4b are diagrams illustrating an example video encoder in conjunction with which some described embodiments can be implemented.

FIG. 5 is a diagram illustrating example IPPMs in some described embodiments.

FIGS. 6a-6c are diagrams illustrating examples of inter/intra decisions using stillness criteria and/or information from a previous picture.

FIG. 7 is a flowchart illustrating a generalized technique for making an inter/intra decision using stillness criteria and/or information from a previous picture.

### DETAILED DESCRIPTION

The detailed description presents innovations in video encoding. In particular, the computational complexity of video encoding can be reduced by selectively skipping certain evaluation stages when deciding whether to use inter-picture prediction or intra-picture prediction for a unit of a picture. For example, based on various conditions, a video encoder selectively skips evaluation of intra-picture prediction modes (“IPPMs”) for blocks of a unit when the IPPMs are not expected to improve the rate-distortion performance of encoding (e.g., by lowering bit rate and/or improving quality). At the same time, selectively skipping evaluation of the IPPMs tends to speed up encoding.

Some of the innovations described herein are illustrated with reference to terms specific to the H.265/HEVC standard. The innovations described herein can also be implemented for other standards or formats (e.g., the VP9 format, H.264/AVC standard).

In the examples described herein, identical reference numbers in different figures indicate an identical component, module, or operation. Depending on context, a given component or module may accept a different type of information as input and/or produce a different type of information as output.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

### I. Example Computing Systems.

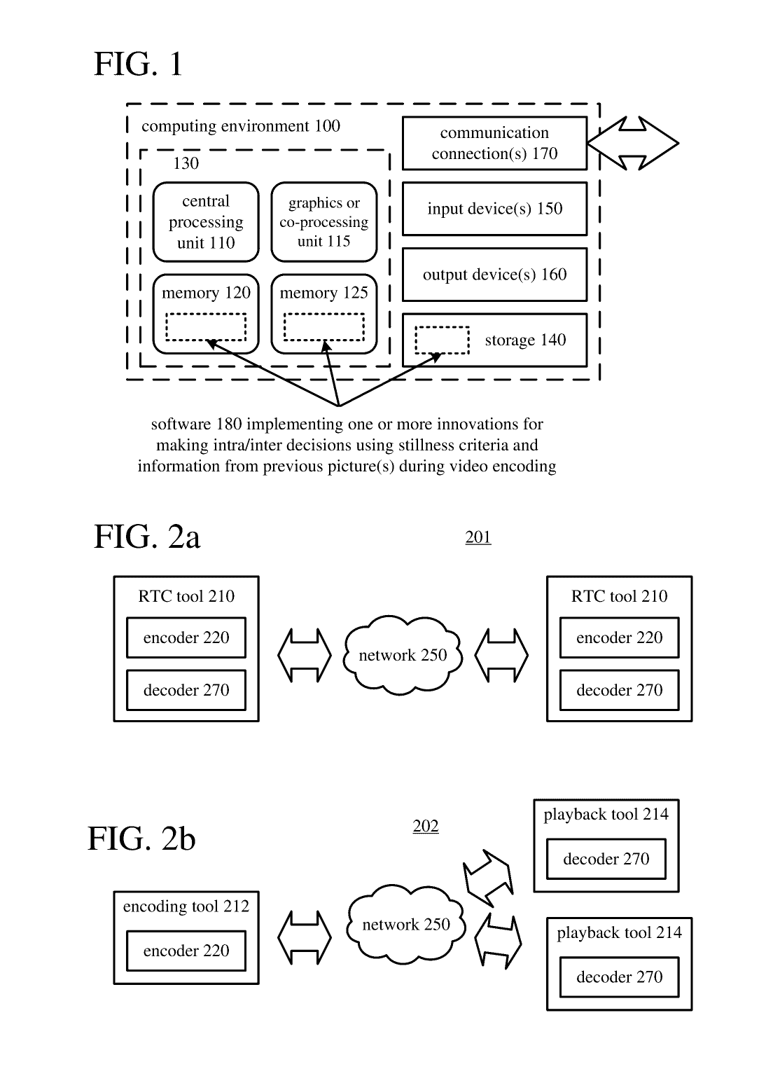

FIG. 1 illustrates a generalized example of a suitable computing system (100) in which several of the described innovations may be implemented. The computing system (100) is not intended to suggest any limitation as to scope of use or functionality, as the innovations may be implemented in diverse general-purpose or special-purpose computing systems.

With reference to FIG. 1, the computing system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for making inter/intra decisions using stillness criteria and information from one or more previous pictures during video encoding, in the form of computer-executable instructions suitable for execution by the processing unit(s).

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, operating system software (not shown) provides an operating environment for other software executing in the computing system (100), and coordinates activities of the components of the computing system (100).

The tangible storage (140) may be removable or non-removable, and includes magnetic disks, magnetic tapes or cassettes, optical media such as CD-ROMs or DVDs, or any other medium which can be used to store information and which can be accessed within the computing system (100). The storage (140) stores instructions for the software (180) implementing one or more innovations for making inter/intra decisions using stillness criteria and information from previous picture(s) during video encoding.

The input device(s) (150) may be a touch input device such as a keyboard, mouse, pen, or trackball, a voice input device, a scanning device, or another device that provides input to the computing system (100). For video, the input device(s) (150) may be a camera, video card, screen capture module, TV tuner card, or similar device that accepts video input in analog or digital form, or a CD-ROM or CD-RW that reads video input into the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system (100), computer-readable media include memory (120, 125), storage (140), and combinations thereof. As used herein, the term computer-readable media does not include transitory signals or propagating carrier waves.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “determine” and “evaluate” to describe computer operations in a computing system. These terms are high-level abstractions for operations performed by a computer, and should not be confused with acts performed by a human being. The actual computer operations corresponding to these terms vary depending on implementation.

### II. Example Network Environments.

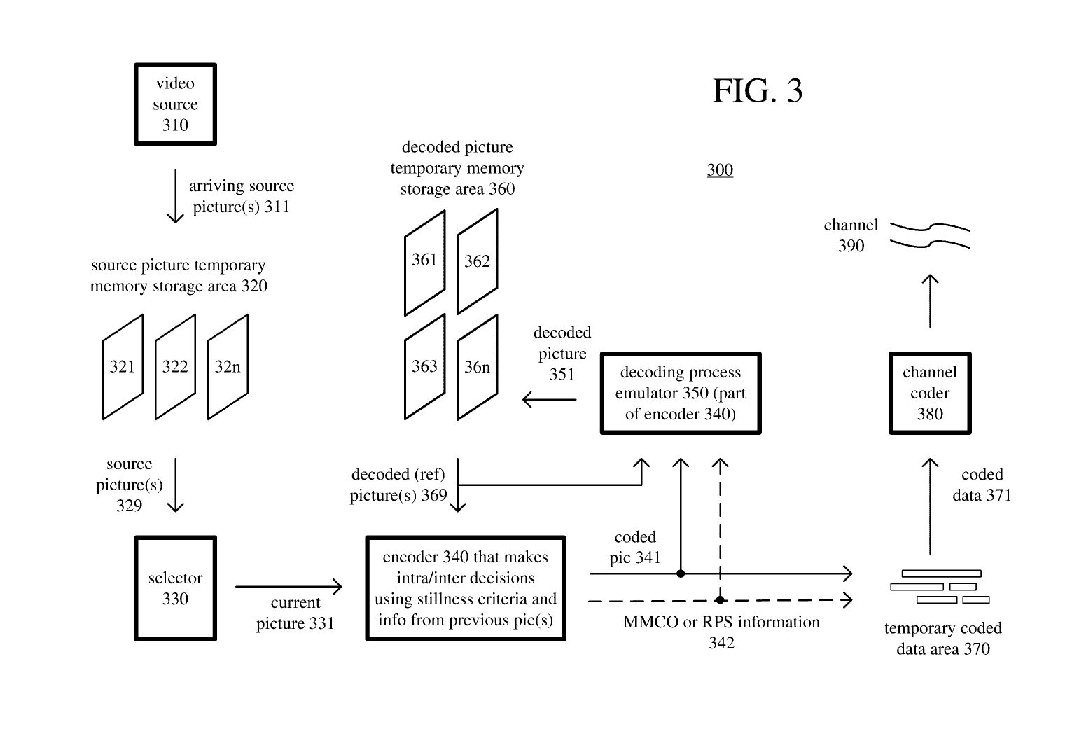

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (“RTC”) tool (210) includes both an encoder (220) and a decoder (270) for bidirectional communication. A given encoder (220) can produce output compliant with the H.265/HEVC standard, SMPTE 421M standard, ISO/IEC 14496-10 standard (also known as H.264/AVC), another standard, or a proprietary format such as VP8 or VP9, or a variation or extension of one of those standards or formats, with a corresponding decoder (270) accepting encoded data from the encoder (220). The bidirectional communication can be part of a video conference, video telephone call, or other two-party or multi-party communication scenario. Although the network environment (201) in FIG. 2a includes two real-time communication tools (210), the network environment (201) can instead include three or more real-time communication tools (210) that participate in multi-party communication.

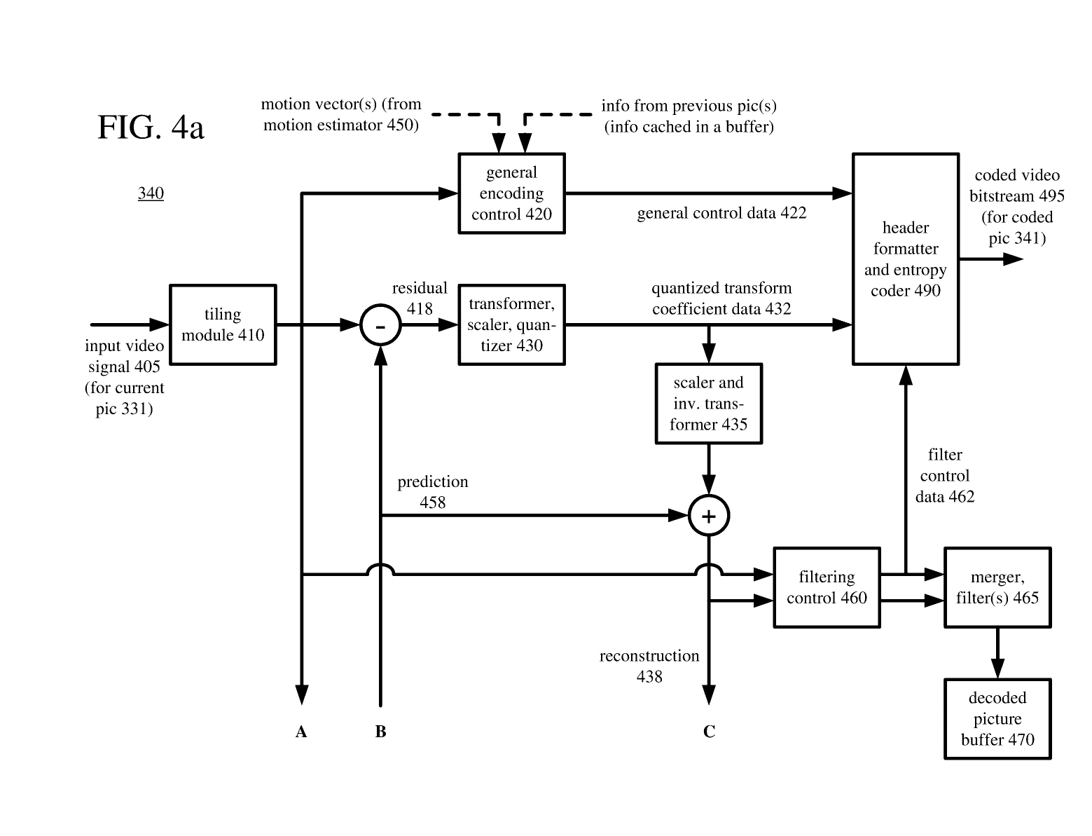

A real-time communication tool (210) manages encoding by an encoder (220). FIG. 3 shows an example encoder system (300) that can be included in the real-time communication tool (210). Alternatively, the real-time communication tool (210) uses another encoder system. A real-time communication tool (210) also manages decoding by a decoder (270).

In the network environment (202) shown in FIG. 2b, an encoding tool (212) includes an encoder (220) that encodes video for delivery to multiple playback tools (214), which include decoders (270). The unidirectional communication can be provided for a video surveillance system, web camera monitoring system, remote desktop conferencing presentation or other scenario in which video is encoded and sent from one location to one or more other locations. Although the network environment (202) in FIG. 2b includes two playback tools (214), the network environment (202) can include more or fewer playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 3 shows an example encoder system (300) that can be included in the encoding tool (212). Alternatively, the encoding tool (212) uses another encoder system. The encoding tool (212) can also include server-side controller logic for managing connections with one or more playback tools (214). A playback tool (214) can include client-side controller logic for managing connections with the encoding tool (212).

### III. Example Encoder Systems.

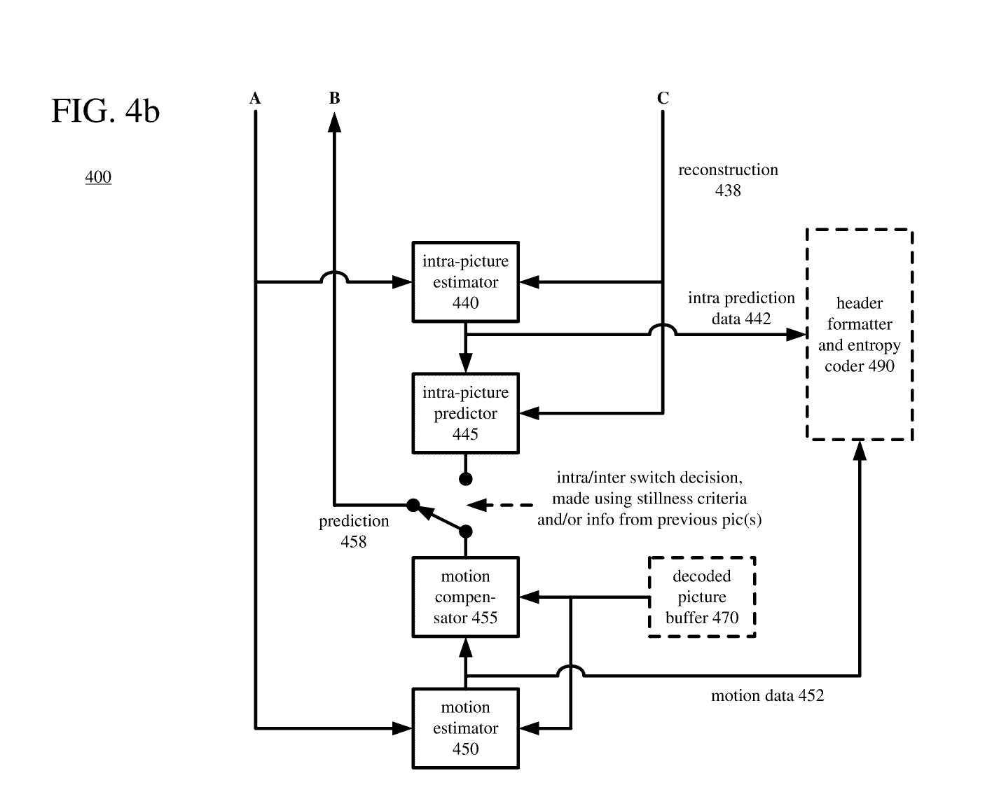

FIG. 3 shows an example video encoder system (300) in conjunction with which some described embodiments may be implemented. The video encoder system (300) includes a video encoder (340), which is further detailed in FIGS. 4a and 4b.

The video encoder system (300) can be a general-purpose encoding tool capable of operating in any of multiple encoding modes such as a low-latency encoding mode for real-time communication, a transcoding mode, and a higher-latency encoding mode for producing media for playback from a file or stream, or it can be a special-purpose encoding tool adapted for one such encoding mode. The video encoder system (300) can be adapted for encoding of a particular type of content. The video encoder system (300) can be implemented as part of an operating system module, as part of an application library, as part of a standalone application, or using special-purpose hardware. Overall, the video encoder system (300) receives a sequence of source video pictures (311) from a video source (310) and produces encoded data as output to a channel (390). The encoded data output to the channel can include content encoded using one or more of the innovations described herein.

The video source (310) can be a camera, tuner card, storage media, screen capture module, or other digital video source. The video source (310) produces a sequence of video pictures at a frame rate of, for example, 30 frames per second. As used herein, the term “picture” generally refers to source, coded or reconstructed image data. For progressive-scan video, a picture is a progressive-scan video frame. For interlaced video, an interlaced video frame might be de-interlaced prior to encoding. Alternatively, two complementary interlaced video fields are encoded together as a single video frame or encoded as two separately-encoded fields. Aside from indicating a progressive-scan video frame or interlaced-scan video frame, the term “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source picture (311) is stored in a source picture temporary memory storage area (320) that includes multiple picture buffer storage areas (321, 322, . . . , 32n). A picture buffer (321, 322, etc.) holds one source picture in the source picture storage area (320). After one or more of the source pictures (311) have been stored in picture buffers (321, 322, etc.), a picture selector (330) selects an individual source picture from the source picture storage area (320) to encode as the current picture (331). The order in which pictures are selected by the picture selector (330) for input to the video encoder (340) may differ from the order in which the pictures are produced by the video source (310), e.g., the encoding of some pictures may be delayed in order, so as to allow some later pictures to be encoded first and to thus facilitate temporally backward prediction. Before the video encoder (340), the video encoder system (300) can include a pre-processor (not shown) that performs pre-processing (e.g., filtering) of the current picture (331) before encoding. The pre-processing can include color space conversion into primary (e.g., luma) and secondary (e.g., chroma differences toward red and toward blue) components and resampling processing (e.g., to reduce the spatial resolution of chroma components) for encoding. Thus, before encoding, video may be converted to a color space such as YUV, in which sample values of a luma (Y) component represent brightness or intensity values, and sample values of chroma (U, V) components represent color-difference values. The precise definitions of the color-difference values (and conversion operations to/from YUV color space to another color space such as RGB) depend on implementation. In general, as used herein, the term YUV indicates any color space with a luma (or luminance) component and one or more chroma (or chrominance) components, including Y′UV, YIQ, Y′IQ and YDbDr as well as variations such as YCbCr and YCoCg. The chroma sample values may be sub-sampled to a lower chroma sampling rate (e.g., for a YUV 4:2:0 format or YUV 4:2:2 format), or the chroma sample values may have the same resolution as the luma sample values (e.g., for a YUV 4:4:4 format). Alternatively, video can be organized according to another format (e.g., RGB 4:4:4 format, GBR 4:4:4 format or BGR 4:4:4 format).

The video encoder (340) encodes the current picture (331) to produce a coded picture (341). As shown in FIGS. 4a and 4b, the video encoder (340) receives the current picture (331) as an input video signal (405) and produces encoded data for the coded picture (341) in a coded video bitstream (495) as output.

Generally, the video encoder (340) includes multiple encoding modules that perform encoding tasks such as partitioning into tiles, intra-picture prediction estimation and prediction, motion estimation and compensation, frequency transforms, quantization, and entropy coding. Many of the components of the video encoder (340) are used for both intra-picture coding and inter-picture coding. The exact operations performed by the video encoder (340) can vary depending on compression format and can also vary depending on encoder-optional implementation decisions. The format of the output encoded data can be Windows Media Video format, VC-1 format, MPEG-x format (e.g., MPEG-1, MPEG-2, or MPEG-4), H.26x format (e.g., H.261, H.262, H.263, H.264, H.265), VPx format, a variation or extension of one of the preceding standards or formats, or another format.

As shown in FIG. 4a, the video encoder (340) can include a tiling module (410). With the tiling module (410), the video encoder (340) can partition a picture into multiple tiles of the same size or different sizes. For example, the tiling module (410) splits the picture along tile rows and tile columns that, with picture boundaries, define horizontal and vertical boundaries of tiles within the picture, where each tile is a rectangular region. Tiles are often used to provide options for parallel processing. A picture can also be organized as one or more slices, where a slice can be an entire picture or section of the picture. A slice can be decoded independently of other slices in a picture, which improves error resilience. The content of a slice or tile is further partitioned into blocks or other sets of sample values for purposes of encoding and decoding. Blocks may be further sub-divided at different stages, e.g., at the prediction, frequency transform and/or entropy encoding stages. For example, a picture can be divided into 64×64 blocks, 32×32 blocks, or 16×16 blocks, which can in turn be divided into smaller blocks of sample values for coding and decoding.

For syntax according to the H.264/AVC standard, the video encoder (340) can partition a picture into one or more slices of the same size or different sizes. The video encoder (340) splits the content of a picture (or slice) into 16×16 macroblocks. A macroblock includes luma sample values organized as four 8×8 luma blocks and corresponding chroma sample values organized as 8×8 chroma blocks. Generally, a macroblock has a prediction mode such as inter or intra. A macroblock includes one or more prediction units (e.g., 8×8 blocks, 4×4 blocks, which may be called partitions for inter-picture prediction) for purposes of signaling of prediction information (such as prediction mode details, motion vector (“MV”) information, etc.) and/or prediction processing. A macroblock also has one or more residual data units for purposes of residual coding/decoding.

For syntax according to the H.265/HEVC standard, the video encoder (340) splits the content of a picture (or slice or tile) into coding tree units. A coding tree unit (“CTU”) includes luma sample values organized as a luma coding tree block (“CTB”) and corresponding chroma sample values organized as two chroma CTBs. The size of a CTU (and its CTBs) is selected by the video encoder. A luma CTB can contain, for example, 64×64, 32×32, or 16×16 luma sample values. A CTU includes one or more coding units. A coding unit (“CU”) has a luma coding block (“CB”) and two corresponding chroma CBs. For example, according to quadtree syntax, a CTU with a 64×64 luma CTB and two 64×64 chroma CTBs (YUV 4:4:4 format) can be split into four CUs, with each CU including a 32×32 luma CB and two 32×32 chroma CBs, and with each CU possibly being split further into smaller CUs according to quadtree syntax. Or, as another example, according to quadtree syntax, a CTU with a 64×64 luma CTB and two 32×32 chroma CTBs (YUV 4:2:0 format) can be split into four CUs, with each CU including a 32×32 luma CB and two 16×16 chroma CBs, and with each CU possibly being split further into smaller CUs according to quadtree syntax.

In H.265/HEVC implementations, a CU has a prediction mode such as inter or intra. A CU includes one or more prediction units for purposes of signaling of prediction information (such as prediction mode details, displacement values, etc.) and/or prediction processing. A prediction unit (“PU”) has a luma prediction block (“PB”) and two chroma PBs. According to the H.265/HEVC standard, for an intra-picture-predicted CU, the PU has the same size as the CU, unless the CU has the smallest size (e.g., 8×8). In that case, the CU can be split into smaller PUs (e.g., four 4×4 PUs if the smallest CU size is 8×8, for intra-picture prediction) or the PU can have the smallest CU size, as indicated by a syntax element for the CU. For an inter-picture-predicted CU, the CU can have one, two, or four PUs, where splitting into four PUs is allowed only if the CU has the smallest allowable size.

In H.265/HEVC implementations, a CU also has one or more transform units for purposes of residual coding/decoding, where a transform unit (“TU”) has a luma transform block (“TB”) and two chroma TBs. A CU may contain a single TU (equal in size to the CU) or multiple TUs. According to quadtree syntax, a TU can be split into four smaller TUs, which may in turn be split into smaller TUs according to quadtree syntax. The video encoder decides how to partition video into CTUs (CTBs), CUs (CBs), PUs (PBs) and TUs (TBs).

In H.265/HEVC implementations, a slice can include a single slice segment (independent slice segment) or be divided into multiple slice segments (independent slice segment and one or more dependent slice segments). A slice segment is an integer number of CTUs ordered consecutively in a tile scan, contained in a single network abstraction layer (“NAL”) unit. For an independent slice segment, a slice segment header includes values of syntax elements that apply for the independent slice segment. For a dependent slice segment, a truncated slice segment header includes a few values of syntax elements that apply for that dependent slice segment, and the values of the other syntax elements for the dependent slice segment are inferred from the values for the preceding independent slice segment in decoding order.

As used herein, the term “block” can indicate a macroblock, residual data unit, CTB, CB, PB or TB, or some other set of sample values, depending on context. The term “unit” can indicate a macroblock, CTU, CU, PU, TU or some other set of blocks, or it can indicate a single block, depending on context.

As shown in FIG. 4a, the video encoder (340) includes a general encoding control (420), which receives the input video signal (405) for the current picture (331) as well as feedback (not shown, except for motion vector(s) and information from previous picture(s), as described below) from various modules of the video encoder (340). Overall, the general encoding control (420) provides control signals (not shown, except for intra/inter switch decision) to other modules, such as the tiling module (410), transformer/scaler/quantizer (430), scaler/inverse transformer (435), intra-picture prediction estimator (440), motion estimator (450) and intra/inter switch, to set and change coding parameters during encoding. The general encoding control (420) can evaluate intermediate results during encoding, typically considering bit rate costs and/or distortion costs for different options. In particular, the general encoding control (420) decides whether to use intra-picture prediction or inter-picture prediction for the units of the current picture (331). As described in the next section, the general encoding control (420) can make intra/inter decisions for the units of the current picture (331) using stillness criteria (based on motion vector(s) from the motion estimator (450)) and information from one or more previous pictures, which is cached in a buffer. In many situations, the general encoding control (420) can help the video encoder (340) avoid time-consuming evaluation of IPPM(s) for blocks of a unit when intra-picture prediction is unlikely to improve rate-distortion performance during encoding for that unit, which tends to speed up encoding. The general encoding control (420) produces general control data (422) that indicates decisions made during encoding, so that a corresponding decoder can make consistent decisions. The general control data (422) is provided to the header formatter/entropy coder (490).

With reference to FIG. 4b, if a unit the current picture (331) is predicted using inter-picture prediction, a motion estimator (450) estimates the motion of blocks of sample values of the unit with respect to one or more reference pictures. The current picture (331) can be entirely or partially coded using inter-picture prediction. When multiple reference pictures are used, the multiple reference pictures can be from different temporal directions or the same temporal direction. The motion estimator (450) potentially evaluates candidate MVs in a contextual motion mode as well as other candidate MVs. For contextual motion mode, as candidate MVs for the unit, the motion estimator (450) evaluates one or more MVs that were used in motion compensation for certain neighboring units in a local neighborhood or one or more MVs derived by rules. The candidate MVs for contextual motion mode can include MVs from spatially adjacent units, MVs from temporally adjacent units, and MVs derived by rules. Merge mode in the H.265/HEVC standard is an example of contextual motion mode. In some cases, a contextual motion mode can involve a competition among multiple derived MVs and selection of one of the multiple derived MVs. The motion estimator (450) can evaluate different partition patterns for motion compensation for partitions of a given unit of the current picture (331) (e.g., 2N×2N, 2N×N, N×2N, or N×N partitions for PUs of a CU in the H.265/HEVC standard).

The decoded picture buffer (470), which is an example of decoded picture temporary memory storage area (360) as shown in FIG. 3, buffers one or more reconstructed previously coded pictures for use as reference pictures. The motion estimator (450) produces motion data (452) as side information. In particular, the motion data (452) can include information that indicates whether contextual motion mode (e.g., merge mode in the H.265/HEVC standard) is used and, if so, the candidate MV for contextual motion mode (e.g., merge mode index value in the H.265/HEVC standard). More generally, the motion data (452) can include MV data and reference picture selection data. The motion data (452) is provided to the header formatter/entropy coder (490) as well as the motion compensator (455). The motion compensator (455) applies MV(s) for a block to the reconstructed reference picture(s) from the decoded picture buffer (470). For the block, the motion compensator (455) produces a motion-compensated prediction, which is a region of sample values in the reference picture(s) that are used to generate motion-compensated prediction values for the block.

With reference to FIG. 4b, if a unit of the current picture (331) is predicted using intra-picture prediction, an intra-picture prediction estimator (440) determines how to perform intra-picture prediction for blocks of sample values of the unit. The current picture (331) can be entirely or partially coded using intra-picture prediction. Using values of a reconstruction (438) of the current picture (331), for intra spatial prediction, the intra-picture prediction estimator (440) determines how to spatially predict sample values of a block of the current picture (331) from neighboring, previously reconstructed sample values of the current picture (331), e.g., estimating extrapolation of the neighboring reconstructed sample values into the block. Examples of IPPMs are described below. As side information, the intra-picture prediction estimator (440) produces intra prediction data (442), such as information indicating whether intra prediction uses spatial prediction and prediction mode direction (for intra spatial prediction). The intra prediction data (442) is provided to the header formatter/entropy coder (490) as well as the intra-picture predictor (445). According to the intra prediction data (442), the intra-picture predictor (445) spatially predicts sample values of a block of the current picture (331) from neighboring, previously reconstructed sample values of the current picture (331), producing intra-picture prediction values for the block.

As shown in FIG. 4b, the intra/inter switch selects whether the predictions (458) for a given unit will be motion-compensated predictions or intra-picture predictions. As described in the next section, intra/inter switch decisions for units of the current picture (331) can be made using stillness criteria and/or information from previous picture(s). In many situations, the video encoder (340) can avoid time-consuming evaluation of IPPM(s) for blocks of a unit when intra-picture prediction is unlikely to improve rate-distortion performance during encoding for that unit, which tends to speed up encoding.

The video encoder (340) can determine whether or not to encode and transmit the differences (if any) between a block's prediction values (intra or inter) and corresponding original values. The differences (if any) between a block of the prediction (458) and a corresponding part of the original current picture (331) of the input video signal (405) provide values of the residual (418). If encoded/transmitted, the values of the residual (418) are encoded using a frequency transform (if the frequency transform is not skipped), quantization, and entropy encoding. In some cases, no residual is calculated for a unit. Instead, residual coding is skipped, and the predicted sample values are used as the reconstructed sample values. The decision about whether to skip residual coding can be made on a unit-by-unit basis (e.g., CU-by-CU basis in the H.265/HEVC standard) for some types of units (e.g., only inter-picture-coded units) or all types of units.

With reference to FIG. 4a, when values of the residual (418) are encoded, in the transformer/scaler/quantizer (430), a frequency transformer converts spatial-domain video information into frequency-domain (i.e., spectral, transform) data. For block-based video coding, the frequency transformer applies a discrete cosine transform (“DCT”), an integer approximation thereof, or another type of forward block transform (e.g., a discrete sine transform or an integer approximation thereof) to blocks of values of the residual (418) (or sample value data if the prediction (458) is null), producing blocks of frequency transform coefficients. The transformer/scaler/quantizer (430) can apply a transform with variable block sizes. In this case, the transformer/scaler/quantizer (430) can determine which block sizes of transforms to use for the residual values for a current block. For example, in H.265/HEVC implementations, the transformer/scaler/quantizer (430) can split a TU by quadtree decomposition into four smaller TUs, each of which may in turn be split into four smaller TUs, down to a minimum TU size. TU size can be 32×32, 16×16, 8×8, or 4×4 (referring to the size of the luma TB in the TU).

In H.265/HEVC implementations, the frequency transform can be skipped. In this case, values of the residual (418) can be quantized and entropy coded. In particular, transform skip mode may be useful when encoding screen content video, but usually is not especially useful when encoding other types of video.

With reference to FIG. 4a, in the transformer/scaler/quantizer (430), a scaler/quantizer scales and quantizes the transform coefficients. For example, the quantizer applies dead-zone scalar quantization to the frequency-domain data with a quantization step size that varies on a picture-by-picture basis, tile-by-tile basis, slice-by-slice basis, block-by-block basis, frequency-specific basis, or other basis. The quantization step size can depend on a quantization parameter (“QP”), whose value is set for a picture, tile, slice, and/or other portion of video. The quantized transform coefficient data (432) is provided to the header formatter/entropy coder (490). If the frequency transform is skipped, the scaler/quantizer can scale and quantize the blocks of prediction residual data (or sample value data if the prediction (458) is null), producing quantized values that are provided to the header formatter/entropy coder (490). When quantizing transform coefficients, the video encoder (340) can use rate-distortion-optimized quantization (“RDOQ”), which is very time-consuming, or apply simpler quantization rules.

As shown in FIGS. 4a and 4b, the header formatter/entropy coder (490) formats and/or entropy codes the general control data (422), quantized transform coefficient data (432), intra prediction data (442), motion data (452), and filter control data (462). The entropy coder of the video encoder (340) compresses quantized transform coefficient values as well as certain side information (e.g., MV information, QP values, mode decisions, parameter choices). Typical entropy coding techniques include Exponential-Golomb coding, Golomb-Rice coding, arithmetic coding, differential coding, Huffman coding, run length coding, variable-length-to-variable-length (“V2V”) coding, variable-length-to-fixed-length (“V2F”) coding, Lempel-Ziv (“LZ”) coding, dictionary coding, and combinations of the above. The entropy coder can use different coding techniques for different kinds of information, can apply multiple techniques in combination (e.g., by applying Golomb-Rice coding followed by arithmetic coding), and can choose from among multiple code tables within a particular coding technique.

The video encoder (340) produces encoded data for the coded picture (341) in an elementary bitstream, such as the coded video bitstream (495) shown in FIG. 4a. In FIG. 4a, the header formatter/entropy coder (490) provides the encoded data in the coded video bitstream (495). The syntax of the elementary bitstream is typically defined in a codec standard or format, or extension or variation thereof. For example, the format of the coded video bitstream (495) can be a Windows Media Video format, VC-1 format, MPEG-x format (e.g., MPEG-1, MPEG-2, or MPEG-4), H.26x format (e.g., H.261, H.262, H.263, H.264, H.265), VPx format, a variation or extension of one of the preceding standards or formats, or another format. After output from the video encoder (340), the elementary bitstream is typically packetized or organized in a container format, as explained below.

The encoded data in the elementary bitstream includes syntax elements organized as syntax structures. In general, a syntax element can be any element of data, and a syntax structure is zero or more syntax elements in the elementary bitstream in a specified order. In the H.264/AVC standard and H.265/HEVC standard, a NAL unit is a syntax structure that contains (1) an indication of the type of data to follow and (2) a series of zero or more bytes of the data. For example, a NAL unit can contain encoded data for a slice (coded slice). The size of the NAL unit (in bytes) is indicated outside the NAL unit. Coded slice NAL units and certain other defined types of NAL units are termed video coding layer (“VCL”) NAL units. An access unit is a set of one or more NAL units, in consecutive decoding order, containing the encoded data for the slice(s) of a picture, and possibly containing other associated data such as metadata.

For syntax according to the H.264/AVC standard or H.265/HEVC standard, a picture parameter set (“PPS”) is a syntax structure that contains syntax elements that may be associated with a picture. A PPS can be used for a single picture, or a PPS can be reused for multiple pictures in a sequence. A PPS is typically signaled separate from encoded data for a picture (e.g., one NAL unit for a PPS, and one or more other NAL units for encoded data for a picture). Within the encoded data for a picture, a syntax element indicates which PPS to use for the picture. Similarly, for syntax according to the H.264/AVC standard or H.265/HEVC standard, a sequence parameter set (“SPS”) is a syntax structure that contains syntax elements that may be associated with a sequence of pictures. A bitstream can include a single SPS or multiple SPSs. An SPS is typically signaled separate from other data for the sequence, and a syntax element in the other data indicates which SPS to use.

As shown in FIG. 3, the video encoder (340) also produces memory management control operation (“MMCO”) signals (342) or reference picture set (“RPS”) information. The RPS is the set of pictures that may be used for reference in motion compensation for a current picture or any subsequent picture. If the current picture (331) is not the first picture that has been encoded, when performing its encoding process, the video encoder (340) may use one or more previously encoded/decoded pictures (369) that have been stored in a decoded picture temporary memory storage area (360). Such stored decoded pictures (369) are used as reference pictures for inter-picture prediction of the content of the current picture (331). The MMCO/RPS information (342) indicates to a video decoder which reconstructed pictures may be used as reference pictures, and hence should be stored in a picture storage area.

With reference to FIG. 3, the coded picture (341) and MMCO/RPS information (342) (or information equivalent to the MMCO/RPS information (342), since the dependencies and ordering structures for pictures are already known at the video encoder (340)) are processed by a decoding process emulator (350). The decoding process emulator (350) implements some of the functionality of a video decoder, for example, decoding tasks to reconstruct reference pictures. In a manner consistent with the MMCO/RPS information (342), the decoding process emulator (350) determines whether a given coded picture (341) needs to be reconstructed and stored for use as a reference picture in inter-picture prediction of subsequent pictures to be encoded. If a coded picture (341) needs to be stored, the decoding process emulator (350) models the decoding process that would be conducted by a video decoder that receives the coded picture (341) and produces a corresponding decoded picture (351). In doing so, when the video encoder (340) has used decoded picture(s) (369) that have been stored in the decoded picture storage area (360), the decoding process emulator (350) also uses the decoded picture(s) (369) from the storage area (360) as part of the decoding process.

The decoding process emulator (350) may be implemented as part of the video encoder (340). For example, the decoding process emulator (350) includes modules and logic as shown in FIGS. 4a and 4b. During reconstruction of the current picture (331), when values of the residual (418) have been encoded/signaled, reconstructed residual values are combined with the prediction (458) to produce an approximate or exact reconstruction (438) of the original content from the video signal (405) for the current picture (331). (In lossy compression, some information is lost from the video signal (405).)

To reconstruct residual values, in the scaler/inverse transformer (435), a scaler/inverse quantizer performs inverse scaling and inverse quantization on the quantized transform coefficients. When the transform stage has not been skipped, an inverse frequency transformer performs an inverse frequency transform, producing blocks of reconstructed prediction residual values or sample values. If the transform stage has been skipped, the inverse frequency transform is also skipped. In this case, the scaler/inverse quantizer can perform inverse scaling and inverse quantization on blocks of prediction residual data (or sample value data), producing reconstructed values. When residual values have been encoded/signaled, the video encoder (340) combines reconstructed residual values with values of the prediction (458) (e.g., motion-compensated prediction values, intra-picture prediction values) to form the reconstruction (438). When residual values have not been encoded/signaled, the video encoder (340) uses the values of the prediction (458) as the reconstruction (438).

For intra-picture prediction, the values of the reconstruction (438) can be fed back to the intra-picture prediction estimator (440) and intra-picture predictor (445). The values of the reconstruction (438) can be used for motion-compensated prediction of subsequent pictures. The values of the reconstruction (438) can be further filtered. A filtering control (460) determines how to perform deblock filtering and sample adaptive offset (“SAO”) filtering on values of the reconstruction (438), for the current picture (331). The filtering control (460) produces filter control data (462), which is provided to the header formatter/entropy coder (490) and merger/filter(s) (465).

In the merger/filter(s) (465), the video encoder (340) merges content from different tiles into a reconstructed version of the current picture. The video encoder (340) selectively performs deblock filtering and SAO filtering according to the filter control data (462) and rules for filter adaptation, so as to adaptively smooth discontinuities across boundaries in the current picture (331). Other filtering (such as de-ringing filtering or adaptive loop filtering (“ALF”); not shown) can alternatively or additionally be applied. Tile boundaries can be selectively filtered or not filtered at all, depending on settings of the video encoder (340), and the video encoder (340) may provide syntax elements within the coded bitstream to indicate whether or not such filtering was applied.

In FIGS. 4a and 4b, the decoded picture buffer (470) buffers the reconstructed current picture for use in subsequent motion-compensated prediction. More generally, as shown in FIG. 3, the decoded picture temporary memory storage area (360) includes multiple picture buffer storage areas (361, 362, . . . , 36n). In a manner consistent with the MMCO/RPS information (342), the decoding process emulator (350) manages the contents of the storage area (360) in order to identify any picture buffers (361, 362, etc.) with pictures that are no longer needed by the video encoder (340) for use as reference pictures. After modeling the decoding process, the decoding process emulator (350) stores a newly decoded picture (351) in a picture buffer (361, 362, etc.) that has been identified in this manner.

As shown in FIG. 3, the coded picture (341) and MMCO/RPS information (342) are buffered in a temporary coded data area (370). The coded data that is aggregated in the coded data area (370) contains, as part of the syntax of the elementary bitstream, encoded data for one or more pictures. The coded data that is aggregated in the coded data area (370) can also include media metadata relating to the coded video data (e.g., as one or more parameters in one or more supplemental enhancement information (“SEI”) messages or video usability information (“VUI”) messages).

The aggregated data (371) from the temporary coded data area (370) is processed by a channel encoder (380). The channel encoder (380) can packetize and/or multiplex the aggregated data for transmission or storage as a media stream (e.g., according to a media program stream or transport stream format such as ITU-T H.222.0 I ISO/IEC 13818-1 or an Internet real-time transport protocol format such as IETF RFC 3550), in which case the channel encoder (380) can add syntax elements as part of the syntax of the media transmission stream. Or, the channel encoder (380) can organize the aggregated data for storage as a file (e.g., according to a media container format such as ISO/IEC 14496-12), in which case the channel encoder (380) can add syntax elements as part of the syntax of the media storage file. Or, more generally, the channel encoder (380) can implement one or more media system multiplexing protocols or transport protocols, in which case the channel encoder (380) can add syntax elements as part of the syntax of the protocol(s). The channel encoder (380) provides output to a channel (390), which represents storage, a communications connection, or another channel for the output. The channel encoder (380) or channel (390) may also include other elements (not shown), e.g., for forward-error correction (“FEC”) encoding and analog signal modulation.

Depending on implementation and the type of compression desired, modules of the video encoder system (300) and/or video encoder (340) can be added, omitted, split into multiple modules, combined with other modules, and/or replaced with like modules. In alternative embodiments, encoder systems or encoders with different modules and/or other configurations of modules perform one or more of the described techniques. Specific embodiments of encoder systems typically use a variation or supplemented version of the video encoder system (300). Specific embodiments of encoders typically use a variation or supplemented version of the video encoder (340). The relationships shown between modules within the video encoder system (300) and video encoder (340) indicate general flows of information in the video encoder system (300) and video encoder (340), respectively; other relationships are not shown for the sake of simplicity.

IV. Intra/Inter Decisions Using Stillness Criteria and Information from Previous Pictures.

This section presents examples of encoding that include selectively skipping certain evaluation stages when deciding whether to use inter-picture prediction or intra-picture prediction for a unit of a picture. In many cases, during encoding of a current unit, based on stillness criteria and/or information from previous pictures, a video encoder can avoid evaluation of intra-picture prediction modes (“IPPMs”) when the IPPMs are unlikely to improve rate-distortion performance, which tends to speed up encoding.

### A. Example IPPMs.

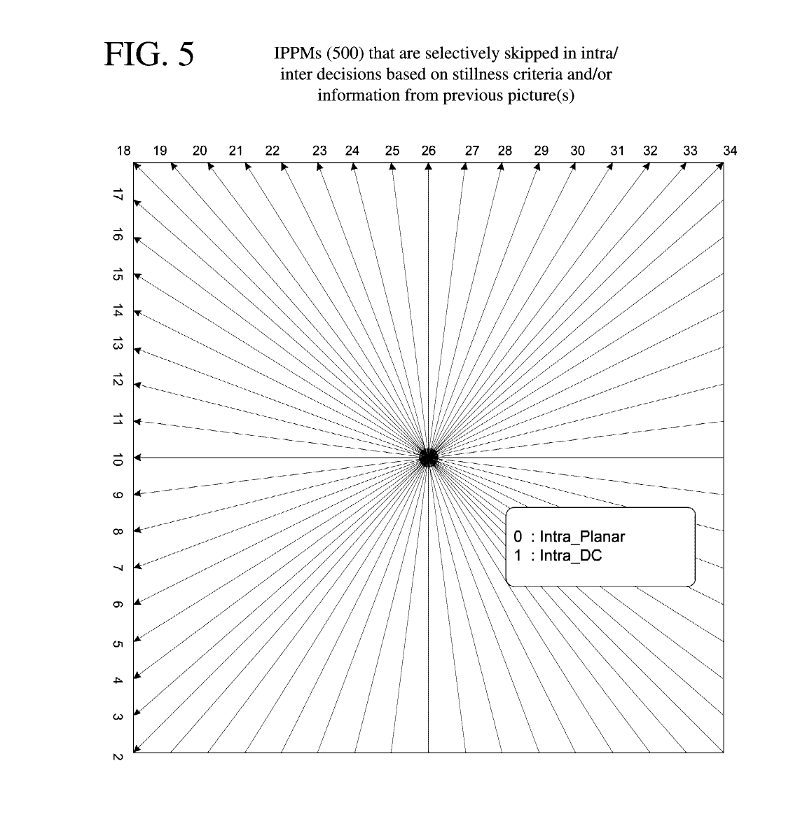

FIG. 5 shows examples of IPPMs (500) according the H.265/HEVC standard. The IPPMs (500) include a DC prediction mode (mode 1), which uses an average value of neighboring reference sample values, and a planar prediction mode (mode 0), which uses average values of two linear predictions (based on corner reference samples). The DC prediction mode (mode 1) and planar prediction mode (mode 0) are non-angular IPPMs. The IPPMs (500) also include 33 angular IPPMs (modes 2-34), which use extrapolation from neighboring reference sample values in different directions, as shown in FIG. 5. Different IPPMs (500) may yield different intra-picture prediction values. Typically, a video encoder evaluates intra-picture prediction values for a block according to one or more of the IPPMs (500) in order to identify one of the IPPMs (500) that provides effective encoding.

Alternatively, a video encoder evaluates other and/or additional IPPMs. For example, the video encoder evaluates one or more of the IPPMs specified for the H.264/AVC standard, VP8 format, or VP9 format.

Depending on the IPPM, computing intra-picture prediction values can be relatively simple (as in IPPMs 10 and 26) or more complicated. One picture can include tens of thousands of blocks. Collectively, evaluating all of the IPPMs for the blocks of a picture, or even evaluating a subset of the IPPMs for the blocks, can be computationally intensive. In particular, the cost of evaluating IPPMs for blocks may be prohibitive for real time video encoding. Therefore, in some examples described herein, a video encoder selectively skips evaluation of IPPMs during intra/inter decisions for units, e.g., based on stillness criteria and/or information from previous picture.

### B. Selectively Skipping Evaluation of IPPMs During Intra/Inter Decisions.

As described with reference to FIGS. 4a and 4b, a video encoder typically decides whether to use intra-picture prediction or inter-picture prediction for a given unit of a picture. In FIG. 4b, the intra/inter switch is set by the video encoder. Considering the computational cost of evaluating IPPMs for blocks of units, using approaches described herein, a video encoder can identify situations in which intra-picture prediction is unlikely to improve rate-distortion performance and, in such situations, skip evaluation of IPPMs.

Typically, a video encoder evaluates inter-picture prediction options before evaluating intra-picture prediction options. Evaluation of inter-picture prediction options can include evaluation of skip mode (or merge mode) as well as motion estimation. In some standards or formats, when a unit is encoded in skip mode, the video encoder uses inter-picture prediction with predicted motion and no residual coding. In some standards or formats, when a unit is encoded in merge mode, the video encoder uses inter-picture prediction with predicted motion and may use residual coding.

A video encoder can consider the results of inter-picture prediction when deciding whether to evaluate IPPMs. For example, in one approach, a video encoder skips evaluation of all IPPMs if skip mode is used for a given unit of a current picture. In some cases, this skip-mode condition fails to catch situations in which intra-picture prediction does not improve rate-distortion performance during encoding. As a result, the video encoder inefficiently evaluates IPPMs for blocks of some units.

A video encoder can also consider information from the current picture when deciding whether to evaluate IPPMs. For example, in another approach, a video encoder analyzes the sample values of a given unit of the current picture, e.g., to determine whether content of the unit is flat, textured, etc. Based on the analysis of the sample values, the video encoder selects a subset of IPPMs to evaluate for blocks of the given unit (skipping evaluation of the remaining IPPMs for blocks of the given unit), or the video encoder skips evaluation of all IPPMs for blocks of the given unit. In some cases, making intra/inter decisions based on information about sample values of the given unit of the current picture does not lead to accurate decisions by the video encoder—it results in inefficient evaluation of IPPMs when intra-picture prediction does not improve performance, or it results in inefficient skipping of evaluation of IPPMs when intra-picture prediction would improve performance.

This section describes additional approaches to selectively skipping evaluation of IPPMs when deciding between intra-picture prediction and inter-picture prediction for a given unit of a current picture. Under these approaches, a video encoder considers various conditions under which evaluation of IPPMs is skipped. For example, a video encoder checks if: (1) stillness criteria are satisfied for a given unit of a current picture; and (2) information from previous picture(s) indicates intra-picture prediction is not promising for the given unit. If the stillness criteria are satisfied and intra-picture prediction is not promising for the given unit, the video encoder skips evaluation of IPPMs for blocks of the given unit. Otherwise (that is, stillness criteria are not satisfied, or intra-picture prediction is promising for the given unit), the video encoder evaluates IPPMs for blocks of the given unit.

In general, the stillness criteria test the level of motion for a given unit, using MV results from motion estimation for the given unit. For example, after one or more MVs are found for the given unit in motion estimation, the video encoder checks whether there is low motion (or no motion) for the given unit, or some other level of motion for the given unit. The threshold for low motion can be whether the magnitude for each MV component (that is, vertical MV component and horizontal MV component) is less than T_{MV} samples. The threshold T_{MV} depends on implementation. For example, the threshold T_{MV} is 1.25 samples for a given MV component. Alternatively, the threshold T_{MV} is 1 sample, 2 samples, 3 samples, or some other number of samples for a given MV component. The threshold T_{MV} can be the same or different for different MV components. If the stillness criteria are not satisfied for the given unit (e.g., either MV component has a magnitude equal to or greater than the applicable threshold T_{MV}), then the video encoder evaluates IPPMs. Intuitively, intra-picture prediction is more likely to improve coding performance in high-motion areas, where inter-picture prediction is less likely to have been successful.

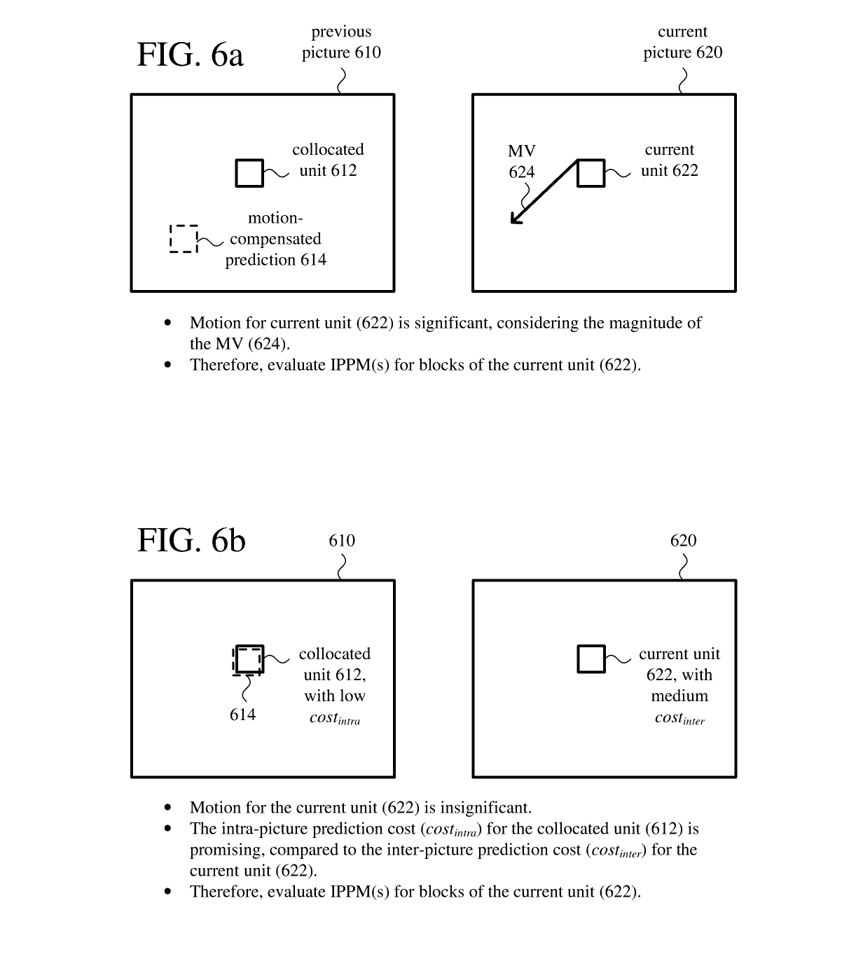

FIG. 6a shows an example of an inter/intra decision based on stillness criteria. The video encoder finds a MV (624) for a current unit (622) of a current picture (620). The MV (624) references a motion-compensated prediction (614) relative to a collocated unit (612) of a previous picture (610), which is used as a reference picture. (As shown in FIG. 6a, the reference picture for motion compensation can be the previous picture. Alternatively, the reference picture for motion compensation can be another picture.) The motion for the current unit (622) is significant, considering the magnitude of the MV (624). Thus, the video encoder evaluates one or more IPPMs for blocks of the current unit (622).

On the other hand, if the stillness criteria are satisfied for the given unit (e.g., each MV component has a magnitude smaller than the applicable threshold T_{MV}), the video encoder checks whether information from previous picture(s) indicates intra-picture prediction is not promising for the given unit. For example, the video encoder determines the collocated unit in a previous picture, which is the unit at the same location as the given unit but in the previous picture. Then, the video encoder determines intra-picture prediction cost information costᵢₙₜᵣₐ for the collocated unit of the previous picture. The intra-picture prediction cost information costᵢₙₜᵣₐ is cached in a buffer. The video encoder uses costᵢₙₜᵣₐ as an estimate of the intra-picture prediction cost of the given unit in the current picture. The video encoder compares costᵢₙₜᵣₐ to inter-picture prediction cost information costᵢₙₜₑᵣ for the given unit in the current picture. For example, the video encoder simply checks whether costᵢₙₜᵣₐ>costᵢₙₜₑᵣ and, if so, determines that intra-picture prediction is not promising for the given unit. Or, the video encoder checks whether costᵢₙₜᵣₐ>w*costᵢₙₜₑᵣ, where w is an implementation dependent weight. For example, w is 1.2. Alternatively, the weight w is 1.5, 2, or some other value. Alternatively, the intra-picture prediction cost information costᵢₙₜᵣₐ is weighted before the comparison. In any case, if the comparison of the intra-picture prediction cost information to the inter-picture prediction cost information indicates intra-picture prediction is not promising, the video encoder skips evaluation of IPPMs for blocks of the given unit.

FIG. 6b shows an example of an inter/intra decision based on stillness criteria and information from a previous picture. In this example, motion is insignificant for the current unit (622) of the current picture (620). The collocated unit (612) of the previous picture (610) has a low intra-picture prediction cost (costᵢₙₜᵣₐ) compared to a medium inter-picture prediction cost (costᵢₙₜₑᵣ) for the current unit (622), which indicates intra-picture prediction is promising. Thus, the video encoder evaluates one or more IPPMs for blocks of the current unit (622).

FIG. 6c shows another example of an inter/intra decision based on stillness criteria and information from a previous picture. In this example, motion is insignificant for the current unit (622) of the current picture (620). The collocated unit (612) of the previous picture (610) has a high intra-picture prediction cost (costᵢₙₜᵣₐ) compared to a low inter-picture prediction cost (costᵢₙₜₑᵣ) for the current unit (622), however, which indicates intra-picture prediction is not promising. Thus, the video encoder skips evaluation of IPPMs for blocks of the current unit (622).

The way that inter-picture prediction cost information costᵢₙₜₑᵣ and intra-picture prediction cost information costᵢₙₜᵣₐ are computed depends on implementation. For example, the inter-picture prediction cost information costᵢₙₜₑᵣ can be a rate-distortion cost for a given unit: costᵢₙₜₑᵣ=Dᵢₙₜₑᵣ+λ·Rᵢₙₜₑᵣ, where Dᵢₙₜₑᵣ is a distortion component that quantifies the coding error for motion-compensated prediction residual values for the given unit, Rᵢₙₜₑᵣ is a rate component that quantifies bitrate for the one or more MVs for the given unit and/or the motion-compensated prediction residual values for the given unit, and λ is a weighting factor. Similarly, the intra-picture prediction cost information costᵢₙₜᵣₐ can be a rate-distortion cost for a given unit: costᵢₙₜᵣₐDᵢₙₜᵣₐ+λ·Rᵢₙₜᵣₐ, where Dᵢₙₜᵣₐ is a distortion component that quantifies the coding error for intra-picture prediction residual values for the given unit, Rᵢₙₜᵣₐ is a rate component that quantifies bitrate for the one or more final IPPMs for blocks of the given unit and/or the intra-picture prediction residual values for the given unit, and X is a weighting factor. The distortion components Dᵢₙₜₑᵣ and Dᵢₙₜᵣₐ can be computed using sum of absolute differences (“SAD”), sum of squared differences (“SSD”), sum of absolute transform differences (“SATD”), or some other measure. The rate components Rᵢₙₜₑᵣ and Rᵢₙₜᵣₐ can be computed using estimates of rates or actual bit counts (after frequency transform, quantization, and/or entropy coding, as applicable). Alternatively, the inter-picture prediction cost information costᵢₙₜₑᵣ and intra-picture prediction cost information costᵢₙₜᵣₐ are computed in some other way.

In some example implementations, the video encoder varies how the distortion components and rate components are computed for the inter-picture prediction cost information costᵢₙₜₑᵣ and intra-picture prediction cost information costᵢₙₜᵣₐ depending on available processing resources (e.g., CPU budget). For example, if processing resources are scarce, the video encoder uses SAD for the distortion components and uses estimates for the rate components. On the other hand, if processing resources are not scarce, the video encoder uses SSD for the distortion component and uses actual bit counts for the rate components. The value of the weighting factor can change depending on how the distortion components and rate components are computed.

In some example implementations, values of intra-picture prediction cost information costᵢₙₜᵣₐ are cached in a buffer for units (e.g., CUs, MBs) of a picture. Initially, the values in the buffer are given a default value (such as −1) that indicates an actual intra-picture prediction cost (costᵢₙₜᵣₐ) is not available. After the units of an intra-picture coded picture have been encoded with intra-picture prediction, the buffer stores values of intra-picture prediction cost information costᵢₙₜᵣₐ for the respective units of the picture, which is now a “previous” picture. For a later picture (as the “current” picture), the value in the appropriate position for a given unit (in the previous picture) can be compared to an inter-picture prediction cost for the given unit (in the current picture), as described above. If a new intra-picture prediction cost (costᵢₙₜᵣₐ) is computed for the given unit (in the current picture), the new intra-picture prediction cost (costᵢₙₜᵣₐ) is cached in the buffer at the position for the given unit, replacing the previous value. On the other hand, if a new intra-picture prediction cost (costᵢₙₜᵣₐ) is not computed for the given unit (in the current picture), the previously cached intra-picture prediction cost information costᵢₙₜᵣₐ remains cached in the buffer at the position for the given unit. Thus, the buffer can store values of intra-picture prediction cost information costᵢₙₜᵣₐ from different previous pictures for different units. Typically, there is a strong correlation in values of intra-picture prediction cost information costᵢₙₜᵣₐ for a given unit from picture-to-picture. As such, the value of intra-picture prediction cost information costᵢₙₜᵣₐ for a given unit in a previous picture is usually a good estimate of the intra-picture prediction cost information costᵢₙₜᵣₐ for the given unit in the current picture.

### C. Generalized Technique for Selectively Skipping Evaluation of IPPMs During Intra/Inter Decisions

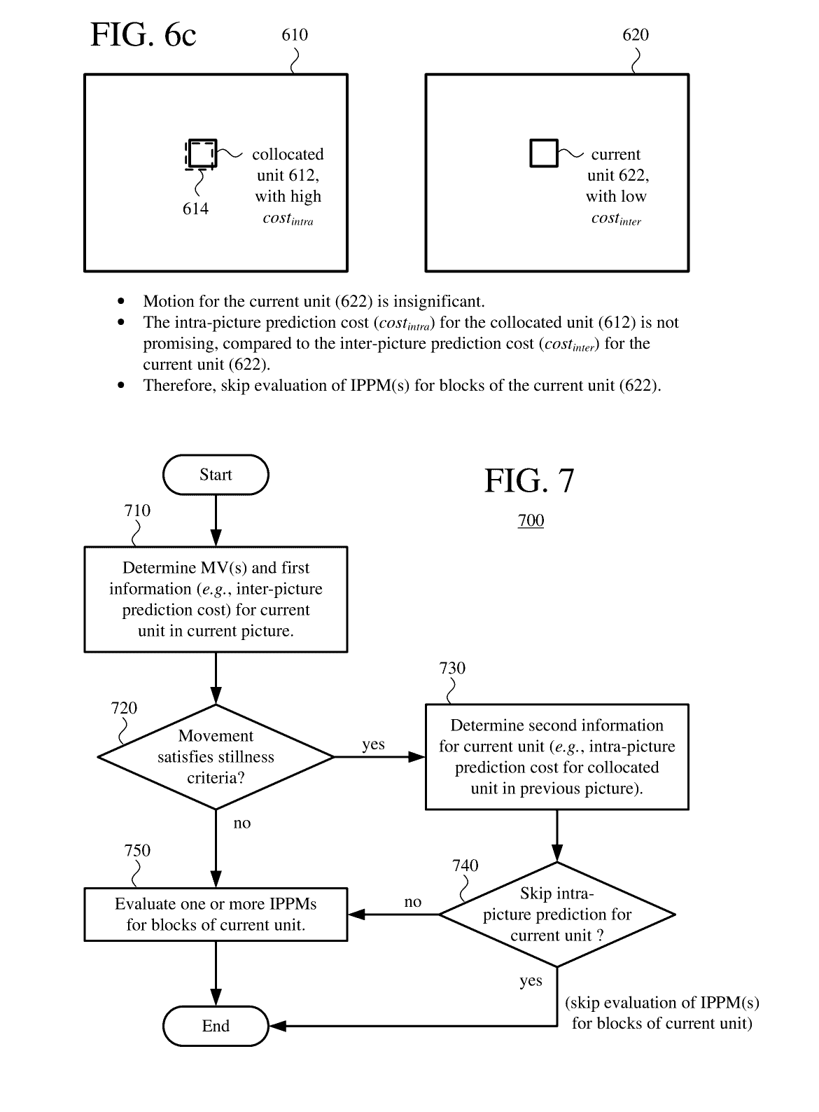

FIG. 7 shows a generalized technique (700) for making an inter/intra decision using stillness criteria and/or information from a previous picture. A video encoder such as the video encoder (340) described with reference to FIGS. 3, 4a, and 4b or other video encoder can perform the technique (700).

The video encoder receives a current picture of a video sequence and encodes the current picture. As part of the encoding the current picture, the video encoder determines (710), for a current unit of the current picture, first information that indicates a cost of encoding the current unit using motion compensation, as well as one or more MVs for the current unit. The current unit can be a CU, macroblock, or other type of unit. For example, the video encoder performs motion estimation for the current unit, which yields the MV(s) for the current unit and inter-picture prediction cost information (example of first information) for the current unit. The first information can estimate a rate-distortion cost having a distortion component and a rate component, where the distortion component quantifies coding error for motion-compensated prediction residual values, and the rate component quantifies bitrate for the MV(s) and/or the motion-compensated prediction residual values. Examples of inter-picture prediction cost information are provided above. Alternatively, in some other way, the first information indicates the cost of encoding the current unit using motion compensation.

The video encoder checks (720) whether movement indicated by the MV(s) for the current unit satisfies stillness criteria. For example, the movement satisfies the stillness criteria if no component of any of the MV(s) has a magnitude larger than an applicable threshold of the stillness criteria. Examples of stillness criteria and thresholds are provided above. Alternatively, the video encoder uses other stillness criteria or other thresholds.

If the movement indicated by the MV(s) for the current unit satisfies the stillness criteria, the video encoder determines (730), for the current unit, second information that indicates a cost of encoding a collocated unit of a previous picture using intra-picture prediction. For example, the video encoder looks up intra-picture prediction cost information (example of second information) in a buffer. The second information can estimate a rate-distortion cost having a distortion component and a rate component, where the distortion component quantifies coding error for intra-picture prediction residual values, and the rate component quantifies bitrate for one or more final IPPMs and/or bitrate for the intra-picture prediction residual values. Examples of intra-picture prediction cost information are provided above. Alternatively, in some other way, the second information indicates the cost of encoding the collocated unit of the previous picture using intra-picture prediction.

Then, the video encoder checks (740), based at least in part on the first information and the second information, whether to skip intra-picture prediction for the current unit. The checking (740) whether to skip intra-picture prediction for the current unit can include, for example, comparing the first information to a weighted version of the second information, or comparing the second information to a weighted version of the first information. Examples of comparisons and weight values are provided above. Alternatively, the video encoder uses another comparison or other weight value.

If intra-picture prediction is skipped for the current unit, the video encoder skips evaluation of IPPMs for blocks of the current unit. Otherwise (intra-picture prediction is not skipped for the current unit at stage 740, or the movement fails to satisfy the stillness criteria at stage 720), the video encoder evaluates (750) one or more IPPMs for blocks of the current unit. The video encoder can determine, for the current unit, new information indicating a cost of encoding the current unit using at least one final (selected) IPPM of the evaluated IPPM(s), and replace the second information with the new information in a buffer. In this way, the new information can be used as part of the inter/inter decision-making process for a collocated unit of a future picture.

The video encoder can repeat the technique (700) on a unit-by-unit basis for the units of the current picture. For example, for H.265/HEVC encoding, the video encoder repeats the technique (700) on a CU-by-CU basis for a picture encoded using inter-picture coding, since the inter/intra decision is made per CU. Or, as another example, for H.264/AVC encoding, the video encoder repeats the technique (700) on an MB-by-MB basis for a picture encoded using inter-picture coding, since the inter/intra decision is made per MB. If the inter/intra decision is made at some other level (e.g., block), the technique (700) can be repeated at that level.

### D. Example Video Encoders with Selective Skipping of Evaluation of IPPMs During Intra/Inter Decisions

With reference to the video encoder (340) shown in FIGS. 4a and 4b, a video encoder that incorporates one of the approaches described in section IV.C includes a motion estimator (450), encoding control (420), intra-picture prediction estimator (440), and buffer (not shown). The motion estimator (450) is configured to determine, for a current unit of a current picture, first information that indicates a cost of encoding the current unit using motion compensation. Different examples for the first information are provided above.

The encoding control (420) is configured to check whether movement indicated by MV(s) for the current unit satisfies stillness criteria, e.g., using conditions and thresholds as described above. The encoding control (420) is further configured to, if movement indicated by MV(s) for the current unit satisfies stillness criteria, determine, for the current unit, second information that indicates a cost of encoding a collocated unit of a previous picture using intra-picture prediction. For example, the encoding control (420) is configured to look up the second information in the buffer, which stores the second information. Different examples for the second information are provided above. The encoding control (420) is also configured to check, based at least in part on the first information and the second information, whether to skip intra-picture prediction for the current unit (e.g., as described above) and, if so, skip evaluation of IPPMs for blocks of the current unit.

The intra-picture prediction estimator (440) is configured to, if intra-picture prediction is promising for the current unit, or if the movement fails to satisfy the stillness criteria, evaluate one or more IPPMs for blocks of the current unit. The encoding control (420) is further configured to, if intra-picture prediction is not to be skipped for the current unit, determine, for the current unit, new information that indicates a cost of encoding the current unit using at least one final (selected) IPPM of the evaluated IPPM(s) and replace the second information with the new information in the buffer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer system comprising a processor and memory, wherein the computer system implements a video encoder system comprising:
a motion estimator configured to determine, for a current unit of a current picture, first information that indicates a cost of encoding the current unit using motion compensation;
a buffer configured to store second information that indicates a cost of encoding a collocated unit of a previous picture using intra-picture prediction;
an encoding control configured to check whether movement indicated by one or more motion vectors for the current unit satisfies stillness criteria, and, if so:
determine, for the current unit, the second information; and
check, based at least in part on the first information and the second information, whether to skip intra-picture prediction for the current unit and, if so, skip the intra-picture prediction for the current unit; and
an intra-picture prediction estimator configured to, if intra-picture prediction is not to be skipped for the current unit, evaluate one or more intra-picture prediction modes (“IPPMs”) for blocks of the current unit.

2. The computer system of claim 1, wherein:
the first information estimates a rate-distortion cost having a first distortion component and a first rate component, the first distortion component quantifying coding error for motion-compensated prediction residual values, and the first rate component quantifying bitrate for the one or more motion vectors and/or the motion-compensated prediction residual values; and
the second information estimates a rate-distortion cost having a second distortion component and a second rate component, the second distortion component quantifying coding error for intra-picture prediction residual values, and the second rate component quantifying bitrate for one or more final IPPMs and/or bitrate for the intra-picture prediction residual values.

3. The computer system of claim 1, wherein the movement satisfies the stillness criteria if no component of any of the one or more motion vectors has a magnitude larger than an applicable threshold of the stillness criteria.

4. The computer system of claim 1, wherein the encoding control is configured to determine the second information by looking up the second information in the buffer.

5. The computer system of claim 1, wherein the encoding control is configured to check whether to skip intra-picture prediction for the current unit by:
comparing the first information to a weighted version of the second information; or
comparing the second information to a weighted version of the first information.

6. The computer system of claim 1, wherein the encoding control is further configured to, if the intra-picture prediction is not to be skipped for the current unit:
determine, for the current unit, new information that indicates a cost of encoding the current unit using at least one final IPPM of the one or more evaluated IPPMs; and
replace the second information with the new information in the buffer.

7. The computer system of claim 1, wherein the intra-picture prediction estimator is further configured to evaluate the one or more IPPMs for blocks of the current unit if the movement fails to satisfy the stillness criteria.

8. The computer system of claim 1, wherein the current unit is a current coding unit or current macroblock.

9. One or more computer-readable media storing computer-executable instructions for causing a processor, when programmed thereby, to perform operations comprising:
receiving a current picture of a video sequence; and
encoding the current picture, including, for a current unit of the current picture:
determining, for the current unit, first information that indicates a cost of encoding the current unit using motion compensation;
checking whether movement indicated by one or more motion vectors for the current unit satisfies stillness criteria; and
if the movement satisfies the stillness criteria:
determining, for the current unit, second information that indicates a cost of encoding a collocated unit of a previous picture using intra-picture prediction; and
checking, based at least in part on the first information and the second information, whether to skip intra-picture prediction for the current unit and, if so, skipping the intra-picture prediction for the current unit.

10. The one or more computer-readable media of claim 9, wherein:
the first information estimates a rate-distortion cost having a first distortion component and a first rate component, the first distortion component quantifying coding error for motion-compensated prediction residual values, and the first rate component quantifying bitrate for the one or more motion vectors and/or the motion-compensated prediction residual values; and
the second information estimates a rate-distortion cost having a second distortion component and a second rate component, the second distortion component quantifying coding error for intra-picture prediction residual values, and the second rate component quantifying bitrate for one or more final intra-picture prediction modes and/or bitrate for the intra-picture prediction residual values.

11. The one or more computer-readable media of claim 9, wherein the movement satisfies the stillness criteria if no component of any of the one or more motion vectors has a magnitude larger than an applicable threshold of the stillness criteria.

12. The one or more computer-readable media of claim 9, wherein the determining the first information includes performing motion estimation for the current unit.

13. The one or more computer-readable media of claim 9, wherein the determining the second information includes looking up the second information in a buffer.

14. The one or more computer-readable media of claim 9, wherein the checking whether to skip intra-picture prediction for the current unit includes:
comparing the first information to a weighted version of the second information; or
comparing the second information to a weighted version of the first information.

15. The one or more computer-readable media of claim 9, wherein the operations further comprise, if the intra-picture prediction is not skipped for the current unit:
evaluating one or more intra-picture prediction modes (“IPPMs”) for blocks of the current unit;
determining, for the current unit, new information indicating a cost of encoding the current unit using at least one final IPPM of the one or more evaluated IPPMs; and
replacing the second information with the new information in a buffer.

16. The one or more computer-readable media of claim 9, wherein the operations further comprise evaluating the one or more intra-picture prediction modes for blocks of the current unit if the movement fails to satisfy the stillness criteria.

17. The one or more computer-readable media of claim 9, wherein the current unit is a current coding unit or current macroblock.

18. In a computer system that implements a video encoder, a method comprising:
receiving a current picture of a video sequence; and
encoding the current picture, including, for a current unit of the current picture:
determining, based on results of motion estimation for the current unit, first information that indicates a cost of encoding the current unit using motion compensation;
checking whether movement indicated by one or more motion vectors for the current unit satisfies stillness criteria; and
if the movement satisfies the stillness criteria:
looking up, in a buffer, second information for the current unit, the second information indicating a cost of encoding a collocated unit of a previous picture using intra-picture prediction; and
checking, based at least in part on the first information and the second information, whether to skip intra-picture prediction for the current unit and, if so, skipping the intra-picture prediction for the current unit.

19. The method of claim 18, wherein the movement satisfies the stillness criteria if no component of any of the one or more motion vectors has a magnitude larger than an applicable threshold of the stillness criteria.

20. The method of claim 18, further comprising, if the intra-picture prediction is not skipped for the current unit:
evaluating one or more intra-picture prediction modes (“IPPMs”) for blocks of the current unit;
determining, for the current unit, new information indicating a cost of encoding the current unit using at least one final IPPM of the one or more evaluated IPPMs; and
replacing the second information with the new information in the buffer.
